(19) United States
(12) Patent Application Publication
(10) Pub. No.: US 2009/0014967 A1
(43) Pub. Date: Jan. 15, 2009

(54) SEALING ARRANGEMENT

(75) Inventor: Herbert MOELLER, Bad Oeynhausen (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/169,153

(22) Filed: Jul. 8, 2008

(30) Foreign Application Priority Data
Jul. 10, 2007 (DE) 10 2007 032 045.2

(51) Int. Cl. F16J 15/02

(52) U.S. Cl. 277/641

(57) ABSTRACT

The disclosure relates to a sealing arrangement for interference radiation-proof connecting of housing elements of electric operating equipment, especially for field housings of programmable controllers. For a sealing arrangement between a first housing section and a second housing section, wherein the first housing section has an encompassing slot into which a rubber-elastic seal is inserted, it is proposed to locate a gap, which is constructed as a labyrinth, before the rubber-elastic seal towards the outer side of the housing, and to locate in each case a flat metallic uncoated sealing face before the rubber-elastic seal towards the inner side of the housing.

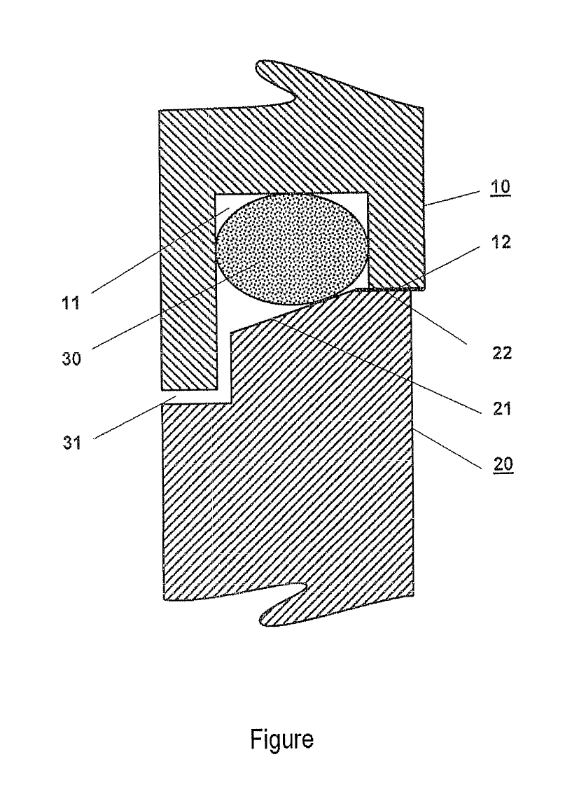

### RELATED APPLICATION

This application claims priority under 35 U.S.C. §119 to German Patent Application No. 10 2007 032 045.2 filed in Germany on Jul. 10, 2007, the entire content of which is hereby incorporated by reference in its entirety.

### TECHNICAL FIELD

The disclosure relates to a sealing arrangement for the interference radiation-proof connecting of housing elements of electrical operating equipment, especially for field housings of programmable controllers.

### BACKGROUND INFORMATION

The electrical operating means of the generic type are equipped with stepped-up electronic circuits, such as microprocessors, which are mounted on a carrier material and communicate with other constructional elements via printed conductors, which are insulated from each other, on this carrier material. In this case, the printed conductors act as antennas which are suitable for transmitting electromagnetic radiation and for interfering with other operating equipment in the process. For ensuring the electromagnetic compatibility (EMV) of pieces of electrical operating equipment, the emission of such interference radiation is to be prevented.

From DE 196 18 766 A1, it is known to provide conductive seals between metallically uncoated contact points on the sealing faces. In the case of pieces of operating equipment which are arranged out in the open, especially within the sphere of influence of aggressive atmosphere, there is the risk of corrosion of the metallically uncoated contact points, as a result of which the conducting contact between the seal and the sealing faces is interrupted.

For aforementioned devices, housings of die-cast aluminum are customarily used, which are lacquered for achieving corrosion resistance. For using conducting seals, however, it is necessary that the contact surfaces with the seals are metallically uncoated. In the case of seals which are held in slots, the slot base in particular must be metallically uncoated. The importance of protecting the contact points against corrosion has already been pointed out in DE 100 60 917 A1 and also in DE 38 15 517 A1. For this purpose, it is specified to provide an adhesion-mediating interlayer, in most cases a chromating or metal oxide coating, for light metals such as magnesium or aluminium.

In the said DE 38 15 517 A1, it is proposed to separate the seal into a non-conducting part consisting of a rubber-elastic material, which is intended for location on surface-protected outer housing sections, and a conducting part, which is intended for location on metallically uncoated inner housing sections. The inner conducting part is partially embedded in the outer rubber-elastic part, and apart from that is clamped between the housing sections. The seal, however, is time-consuming and complicated in handling.

EP 668 692 B1 shows an arrangement with a cylindrical vessel, the ends of which are closed off by caps which have an annular slot in which a seal against electromagnetic radiation is located.

Furthermore, an arrangement which comprises a cup-shaped cap and a baseplate which projects outwards on the outer surface, in which the cap is seated upon the projections, is shown in EP 803 174 B1.

### SUMMARY

Exemplary embodiments disclosed here can create a sealing arrangement for the screening of electromagnetic radiation, which avoids the escape of this radiation from a housing cavity.

A sealing arrangement between a first housing section and a second housing section is disclosed, wherein the first housing section has an encompassing slot into which a rubber-elastic seal is inserted, wherein a gap, which is constructed as a labyrinth, is located before the rubber-elastic seal towards the outer side of the housing, and a flat metallically uncoated sealing face is located in each case before the rubber-elastic seal towards the inner side of the housing.

In another aspect, a sealing arrangement for a housing having inner and outer sides is disclosed, comprising: a first housing section, the first housing section having an encompassing slot into which a rubber-elastic seal is inserted; and a second housing section. A gap is located before the rubber-elastic seal towards the outer side of the housing, and a flat metallically uncoated sealing face is located in each case before the rubber-elastic seal towards the inner side of the housing.

### BRIEF DESCRIPTION OF THE DRAWING

Further details and advantages of the disclosure are subsequently explained in more detail based on an exemplary embodiment. The single FIGURE shows in a sectional basic representation an exemplary sealing arrangement between a first metallic housing section and a second metallic housing section.

### DETAILED DESCRIPTION

The disclosure is based on a sealing arrangement between a first metallic housing section and a second metallic housing section, wherein the first housing section has an encompassing slot into which a rubber-elastic seal is inserted.

According to the disclosure, a gap, which is constructed as a labyrinth, is located before the rubber-elastic seal towards the outer side of the housing, and a flat metallically uncoated sealing face is located in each case before the rubber-elastic seal towards the inner side of the housing. The sealing face of the second housing section, which lies opposite the slot, is conically bevelled.

During the specified use of the sealing arrangement, the metallically uncoated sealing faces of the first and the second housing sections lie upon each other and seal off the inner cavity of the housing largely against incoming and/or outgoing electromagnetic radiation. The rubber-elastic seal lies in the slot and upon the conically bevelled sealing face, and protects the metallically uncoated sealing faces of the first and second housing sections against external corrosive attack. The preceding labyrinth gap further damps out incoming and/or outgoing electromagnetic radiation.

The single FIGURE shows in a sectional basic representation a sealing arrangement between a first metallic housing section 10 and a second metallic housing section 20. In this case, the first housing section 10 has an encompassing slot 11 into which a rubber-elastic seal 30 is inserted.

A gap 31, which is constructed as a labyrinth, is located before the rubber-elastic seal 30 towards the outer side of the housing. Towards the inner side of the housing, the first housing section 10 has a flat metallically uncoated sealing face 12, and the second housing section 20 has a flat metallically uncoated sealing face 22. During the specified use of the sealing arrangement the metallically uncoated sealing faces 12 and 22 of the first and second housing sections 10 and 20 lie upon each other in a frictionally locking manner.

The sealing face 21 of the second housing section 20, which lies opposite the slot 11, is conically bevelled. The wall surfaces of the slot 11, the sealing face 21 of the second housing section 20, which lies opposite the slot 11, and also the wall surfaces of the gap 31, which is constructed as a labyrinth, have a corrosion-inhibiting coating. This coating can be effected as lacquering, oxidizing, chromating, or by means of another suitable passivation. In this case, all provided surfaces of the respective housing sections 10 and 20 are first coated in a first working step. In a second working step, the metallically uncoated sealing faces 12 and 22 are produced by means of metal-cutting machining. In doing so, the sealing face 12 is machined on its entire width of the member which delimits the slot 11. The machined surface of the second housing section 20 is variable for producing the metallically uncoated sealing face 22, and as machining depth increases merges into the conically bevelled sealing face 21. As a result, contact-impeding steps in the metallically uncoated sealing face 22 are avoided and the machining of the sealing face 21 is made easier.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF DESIGNATIONS

10 First housing section
11 Slot
12 Uncoated sealing face
20 Second housing section
21 Conical sealing face
22 Uncoated sealing face
30 Rubber-elastic seal
31 Labyrinth gap

What is claimed is:

1. A sealing arrangement between a first housing section and a second housing section, wherein the first housing section has an encompassing slot into which a rubber-elastic seal is inserted, wherein
a gap, which is constructed as a labyrinth, is located before the rubber-elastic seal towards the outer side of the housing, and a flat metallically uncoated sealing face is located in each case before the rubber-elastic seal towards the inner side of the housing.

2. The sealing arrangement as claimed in claim 1, wherein
the sealing face of the second housing section, which lies opposite the slot, is conically bevelled.

3. The sealing arrangement as claimed in claim 2. wherein
the sealing face of the second housing section, which lies opposite the slot, has a corrosion-inhibiting coating.

4. The sealing arrangement as claimed in claim 1, wherein
the wall surfaces of the slot have a corrosion-inhibiting coating.

5. The sealing arrangement as claimed in claim 1, wherein
the wall surfaces of the gap, which is constructed as a labyrinth, have a corrosion-inhibiting coating.

6. The sealing arrangement as claimed in claim 3, wherein
the wall surfaces of the slot have a corrosion-inhibiting coating.

7. The sealing arrangement as claimed in claim 4, wherein
the wall surfaces of the gap, which is constructed as a labyrinth, have a corrosion-inhibiting coating.

8. A sealing arrangement for a housing having inner and outer sides, comprising:
a first housing section, the first housing section having an encompassing slot into which a rubber-elastic seal is inserted; and
a second housing section, wherein a gap is located before the rubber-elastic seal towards the outer side of the housing, and a flat metallically uncoated sealing face is located in each case before the rubber-elastic seal towards the inner side of the housing.

9. The sealing arrangement as claimed in claim 8, wherein the gap is constructed as a labyrinth.
